(19) United States
(12) Patent Application Publication
(10) Pub. No.: US 2008/0136316 A1
(43) Pub. Date: Jun. 12, 2008

(54) ORGANIC LIGHT EMITTING DISPLAY

(76) Inventor: Sa-Bang Um, Yongin-si (KR)

Correspondence Address: CHRISTIE, PARKER & HALE, LLP, PO BOX 7068, PASADENA, CA, 91109-7068, US

(21) Appl. No.: 11/696,697

(22) Filed: Apr. 4, 2007

(30) Foreign Application Priority Data
Dec. 6, 2006 (KR) 10-2006-0122993

(51) Int. Cl. H01J 1/62

(52) U.S. Cl. 313/504

(57) ABSTRACT

Provided is an organic light emitting display including a base substrate, an organic light emitting portion formed on a side of the base substrate, and a sealing substrate that encloses the organic light emitting portion and is disposed to be sealed with the base substrate, wherein the sealing substrate includes a barrier for surrounding the organic light emitting portion, wherein the barrier includes a groove, and wherein a desiccant is disposed in the groove.

### CROSS-REFERENCE TO RELATED PATENT APPLICATION

This application claims priority to and the benefit of Korean Patent Application No. 10-2006-0122993, filed on Dec. 6, 2006 in the Korean Intellectual Property Office, the entire content of which is incorporated herein by reference.

### BACKGROUND OF THE INVENTION

1. Field of the Invention

The present invention relates to an organic light emitting display, and more particularly, to an organic light emitting display which inhibits moisture from permeating the organic light emitting display.

2. Description of the Related Art

An organic light emitting display is a self-emissive type of display apparatus that uses electrons and holes injected through an anode and a cathode recombined in an organic material to form excitons. Light of a specific wavelength is then generated by energy from the excitons.

Since the organic light emitting display does not require an additional light source such as a backlight, power consumption is low compared with a liquid crystal display apparatus. In addition, the organic light emitting display provides a wide viewing angle and a fast response speed. Therefore, the organic light emitting display is widely regarded as a next generation display apparatus.

A light emitting element of the organic light emitting display includes an anode electrode as a hole injection electrode, an organic thin film layer, and a cathode electrode as an electron injection electrode. The organic thin film layer includes organic materials to emit red (R), green (G), and blue (B) so as to implement a full color spectrum.

Alternatively, the organic thin film layer may have a multilayered structure including an emitting layer (EML), an electron transport layer (ETL), and a hole transport layer (HTL) to balance electrons and holes. In some cases, the organic thin film layer may further include a separate electron injection layer (EIL) and a hole injection layer (HIL) as needed.

However, the aforementioned organic thin film layer deteriorates when moisture permeates the layer. Accordingly, there is a need to prevent the permeation of moisture into the organic thin film. A conventional organic light emitting display may include a desiccant therein. The desiccant may be formed as a powder to be disposed in a metal can or in a glass substrate groove, or it may have a film attached by double-sided adhesive tape. However, even when a desiccant is provided, the permeation of moisture or oxygen into the organic light emitting display is not completely prevented.

In particular, when the organic light emitting display has a top emission structure, the desiccant is provided at the sealing substrate. Therefore, although a transparent desiccant is used, light transmittance of the display apparatus is affected. Therefore, the use of the desiccant is limited.

### SUMMARY OF THE INVENTION

In an exemplary embodiment of the present invention, an organic light emitting display is provided including a base substrate, an organic light emitting portion formed on the base substrate, and a sealing substrate enclosing the organic light emitting portion for sealing the organic light emitting display. The sealing substrate includes a barrier for surrounding the organic light emitting portion. The barrier includes a groove wherein a desiccant made of, for example, an epoxy resin is disposed.

The organic light emitting display may also include a sealing element disposed between the barrier and the base substrate as well as a moisture absorption layer attached to an inner surface of the sealing substrate. The moisture absorption layer is made of a transparent material that may be attached to the sealing substrate by adhesive tape.

### BRIEF DESCRIPTION OF THE DRAWINGS

FIG. 1 is a cross-sectional view showing an organic light emitting display according to an embodiment of the present invention.

### DETAILED DESCRIPTION OF THE EMBODIMENTS

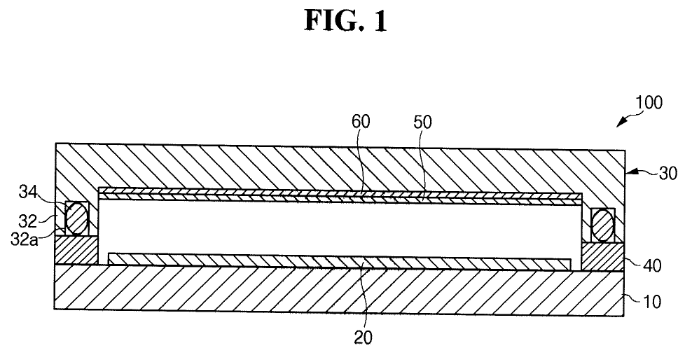

Referring to FIG. 1, an organic light emitting display 100 includes a base substrate 10, an organic light emitting portion 20 formed on the base substrate 10, and a sealing substrate 30 formed above the organic light emitting portion 20 to seal the base substrate 10. In addition, a sealing element 40 is disposed between the base substrate 10 and the sealing substrate 30 to seal the base substrate 10 and the sealing substrate 30 to each other.

The base substrate 10 may be an insulating material such as glass or plastic. The organic light emitting portion 20 may include a first electrode, an organic thin film layer, and a second electrode that are sequentially stacked. In one exemplary embodiment, the first electrode may be an anode electrode, and the second electrode may be a cathode electrode.

The organic thin film layer may be a small molecule organic material or a polymeric organic material. The small molecule organic material may have a multilayered structure including an HIL, an HTL, an EML, and an ETL.

The polymeric organic material may include an HTL and an EML. In one exemplary embodiment, the HTL may be made of a Poly(3,4-ethylenedioxythiophene) (PEDOT) material, and the EML may be made of a polyphenylenevinylene-based material or a polyfluorene-based material.

The sealing substrate 30 may be made of a metal cap, a transparent glass material, or a transparent plastic material. However, when the organic light emitting display 100 is a top emission type or a dual emission type for implementing an image in a direction toward the sealing substrate 30 or toward both the base substrate 10 and the sealing substrate 30, the sealing substrate 30 may be transparent glass or a transparent plastic material.

The sealing substrate 30 includes a barrier 32 for surrounding the organic light emitting portion 20. The barrier 32 is attached to the base substrate 10 by the sealing element 40. The barrier 32 may include a groove 32a in which a desiccant 34 is disposed. The desiccant 34 may be made of an epoxy resin so as to effectively prevent permeation of moisture between the sealing element 40 and the barrier 32 of the sealing substrate 30.

An inner surface of the sealing substrate 30 facing the organic light emitting portion 20 includes a moisture absorption layer 50 for absorbing moisture in a space between the base substrate 10 and the sealing substrate 30. The moisture absorption layer 50 may be made of a material having high moisture absorption characteristics, such as an alkali metal oxide, an alkali earth metal oxide, a rare earth oxide, an aluminum oxide, zeolite, or the like. The moisture absorption layer 50 may be attached to the sealing substrate 30 with double-sided adhesive tape 60. A pad region provided with wire lines connected to electrode layers disposed on the organic light emitting portion 20 to externally input and output signals is formed on a region on the base substrate 10 excluding the sealing substrate 30

As described above, according to an exemplary embodiment of the organic light emitting display according to the present invention, a desiccant is disposed inside a barrier to improve moisture permeability prevention. In addition, an organic light emitting display with a top emission type may form a thinner moisture absorption layer, to allow improved light transmittance.

While this invention has been described in connection with what is presently considered to be a practical exemplary embodiment, it is to be understood that the invention is not limited to the disclosed embodiment, but rather is intended to cover various modifications and equivalent arrangements included within the spirit and scope of the appended claims.

What is claimed is:

1. An organic light emitting display comprising:
a base substrate;
an organic light emitting portion formed on the base substrate; and
a sealing substrate enclosing the organic light emitting portion for sealing the organic light emitting display, the sealing substrate including a barrier formed along a periphery of the sealing substrate and extending toward the base substrate, the barrier surrounding the organic light emitting portion;
wherein the barrier includes a groove, and
wherein a desiccant is disposed in the groove.

2. The organic light emitting display of claim 1, wherein the desiccant is made of an epoxy resin.

3. The organic light emitting display of claim 1, further comprising a sealing element disposed between the barrier and the base substrate.

4. The organic light emitting display of claim 1, further comprising a moisture absorption layer attached to an inner surface of the sealing substrate.

5. The organic light emitting display of claim 4, wherein the moisture absorption layer is made of a transparent material.

6. The organic light emitting display of claim 5, wherein the moisture absorption layer is attached to the sealing substrate by an adhesive tape.

7. A method of preventing moisture from permeating an organic light emitting display, the organic light emitting display including a base substrate, an organic light emitting portion formed on the base substrate, and a sealing substrate that encloses the organic light emitting portion and is disposed to be sealed with the base substrate, the sealing substrate including a barrier for surrounding the organic light emitting portion, the method comprising:
locating a groove on the barrier; and
disposing a desiccant in the groove.

8. The method of claim 7, wherein the desiccant is epoxy resin.

9. The method of claim 7, further comprising locating a sealing element between the barrier and the base substrate.

10. The method of claim 7, further comprising attaching a moisture absorption layer to an inner surface of the sealing substrate.

11. The method of claim 10, wherein the moisture absorption layer is a transparent material.

12. An organic light emitting display comprising:
a base substrate;
an organic light emitting portion formed on the base substrate;
a sealing substrate that encloses the organic light emitting portion and is disposed to be sealed with the base substrate, the sealing substrate including a barrier formed along a periphery of the sealing substrate and extending toward the base substrate surrounding the organic light emitting portion;
a sealing element disposed between the barrier and the base substrate; and
a moisture absorption layer attached to an inner surface of the sealing substrate;
wherein the barrier includes a groove, and
wherein a desiccant is disposed in the groove.
